(19) United States
(12) Patent Application Publication
(10) Pub. No.: US 2016/0250770 A1
(43) Pub. Date: Sep. 1, 2016

(54) GAS-ACTUATED HOLD-DOWN FOR PUNCHING DEVICES AND PUNCHING DEVICE WITH SUCH HOLD-DOWN

(71) Applicant: SPECIAL SPRINGS S.R.L., Romano D'Ezzelino (IT)

(72) Inventors: Massimo FIORESE, Bassano Del Grappa (IT); Daniel FANTINATO, Bassano Del Grappa (IT); Roberto RECH, Nove (IT)

(73) Assignee: SPECIAL SPRINGS S.R.L., Romano D'Ezzelino (IT)

(21) Appl. No.: 15/049,278

(22) Filed: Feb. 22, 2016

(30) Foreign Application Priority Data
Feb. 27, 2015 (IT) PD2015A000049

(51) Int. Cl. B26D 7/02; B26F 1/02

(52) U.S. Cl. CPC B26D 7/025; B26F 1/02

(57) ABSTRACT

A gas-actuated hold-down for punching devices comprising:
a tubular containment body,
a hold-down element, adapted to translate within the tubular body in order to protrude from and retract into a first end thereof,
a tubular punch die-covering element, which is coaxial to the tubular body, for guiding the hold-down element,
an annular closure body, designed to close the tubular containment body at an opposite second end thereof,
a pressure chamber defined between the tubular body, the tubular punch die-covering element, the hold-down element and the annular closure body,
a fixing flange, which widens radially from the tubular containment body at the second end thereof,
the fixing flange having a through charging hole which extends in a radial direction with respect to a main axis of the hold-down, from a surface that is exposed in a configuration for use of the hold-down up to the pressure chamber.

The present invention relates to a gas-actuated hold-down for punching devices.

The invention also relates to a punching device with such hold-down.

In order to carry out punching or cutting operations, in particular for the mass production of metallic components in sheet metal for example for the automotive sector or for the electrical household appliances sector, usually presses are used, and one or more punching devices with a hold-down are applied to the sliders of such presses, while corresponding matrix dies are associated with the fixed part of the same presses; the sheet metal to be worked is placed on such matrix dies, and the punch dies, by descending, enter the matrix dies to effect the removal of material.

Nowadays gas-actuated hold-downs for punching units are known, which comprise:
a tubular containment body,
a hold-down element, adapted to translate within the tubular body in order to protrude from and retract into a first end thereof,
a tubular punch die-covering element, which is coaxial to the tubular body, for guiding the hold-down element,
an annular closure body, designed to close the tubular containment body at the opposite second end thereof,
a pressure chamber defined between the tubular body, the tubular punch die-covering element, the hold-down element and the annular closure body,
a fixing flange, which widens radially from the tubular containment body at the second end thereof.

The fixing flange is provided with a through hole for charging gas which extends toward the pressure chamber from a face of the fixing flange, or from a face of the second end, of the tubular containment body, such face being designed to be facing a slider of a press, or a corresponding punch die support, on which the hold-down must be mounted.

In this manner such gas charging hole, with the corresponding charging valve mounted internally, is no longer reachable once the hold-down is fitted and operational, since such charging hole is obstructed by the slider, or by the punch die support, on which it is mounted.

The gas charging hole in such position allows the recharging of the gas-actuated hold-down only with the removal of the hold-down proper from the slider, or from the punch die support, on which it is mounted, in order to allow the operator to access the charging hole which is not accessible when the hold-down is mounted on the slider or on the punch die support.

The operation to restore the pressure in a hold-down becomes burdensome in terms of time and labor, since it must be periodically done for all of the numerous punching devices that are mounted on a slider of a press.

Nowadays punching devices are also known and widespread which comprise a punch die-supporting body, to be interposed between the hold-down and the slider of the press, and provided internally with means for quick and reversible coupling for a punch.

A hold-down is usually fixed to the punch die support with one or more threaded elements of standard type.

Owing to the play between the threadings of standard screws and the corresponding complementarily threaded holes for screwing, such fixing system can determine problems of imprecise centering for the hold-down, with consequent risk of carrying out correspondingly imprecise punching operations which require operations to make good the punched piece if it is not discarded.

The aim of the present invention is to provide a gas-actuated hold-down for punching devices which is capable of overcoming the above mentioned drawbacks of conventional hold-downs.

Within this aim, an object of the invention is to provide a hold-down thanks to which the operations to recharge the gas and restore the pressure are more convenient and rapid to carry out with respect to conventional hold-downs.

Another object of the invention is to provide a punching device that is capable of overcoming the above mentioned drawbacks of conventional punching devices.

This aim and these and other objects which will become better apparent hereinafter are achieved by a gas-actuated hold-down for punching devices, which is characterized in that it comprises:
a tubular containment body,
a hold-down element, adapted to translate within said tubular body in order to protrude from and retract into a first end thereof,
a tubular punch die-covering element, which is coaxial to said tubular body, for guiding said hold-down element,
an annular closure body, designed to close said tubular containment body at an opposite second end thereof,
a pressure chamber defined between said tubular body, said tubular punch die-covering element, said hold-down element and said annular closure body,
a fixing flange, which widens radially from said tubular containment body at said second end thereof,
said fixing flange having a through charging hole which extends in a radial direction with respect to a main axis of the hold-down, from a surface that is exposed in a configuration for use of the hold-down up to said pressure chamber.

Advantageously, a punching device with a hold-down according to such inventive concept comprises:
a punch die-supporting body with means for quick and reversible coupling for a punch,
means for the precision fixing of said hold-down to said punch die-supporting body.

Further characteristics and advantages of the invention will become better apparent from the detailed description that follows of a preferred, but not exclusive, embodiment, of the hold-down according to the invention, and of the punching device according to the invention, which are illustrated for the purposes of non-limiting example in the accompanying drawings wherein:

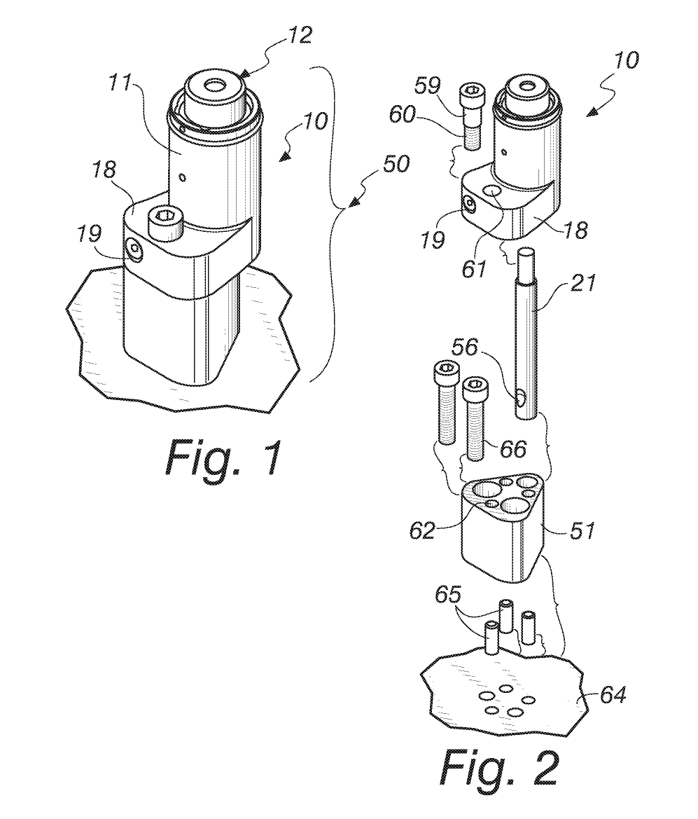

FIG. 1 shows a hold-down according to the invention and a punching device according to the invention which comprises it;

FIG. 2 is an exploded perspective view of FIG. 1;

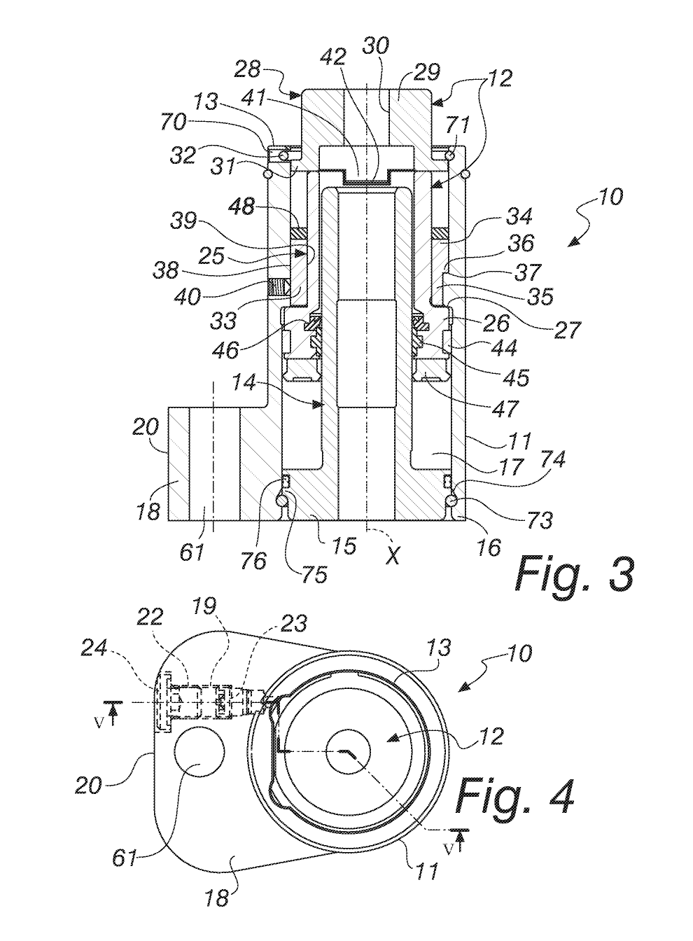

FIG. 3 is a cross-sectional side view of the hold-down according to the invention;

FIG. 4 is a view from above of the hold-down according to the invention;

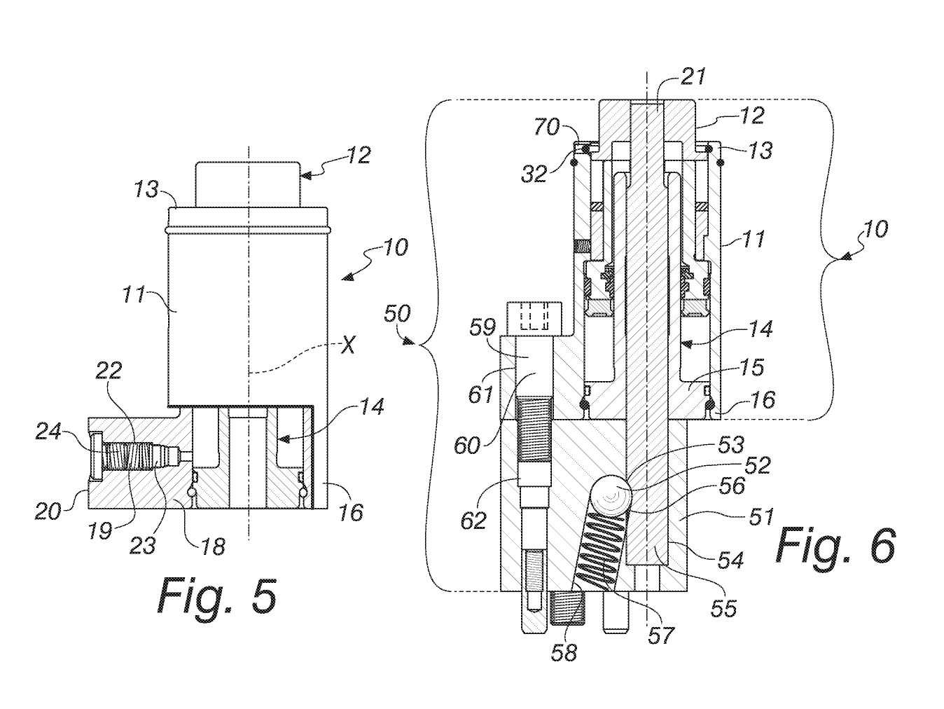

FIG. 5 is a cross-sectional view taken along the line V-V in FIG. 4;

FIG. 6 is a cross-sectional side view of the punching device according to the invention in a first embodiment thereof;

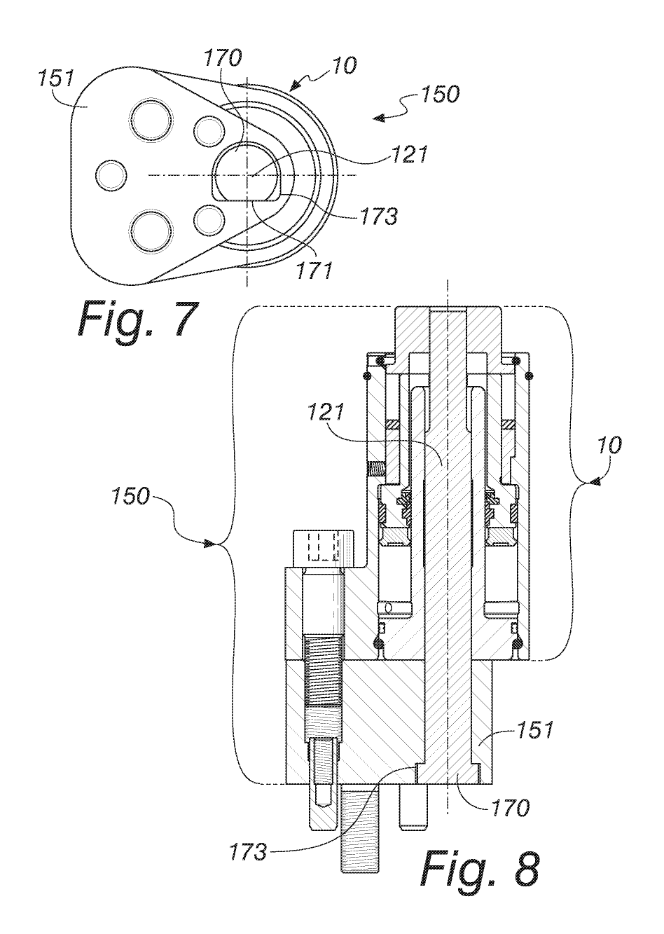

FIG. 7 is a plan view from below of the punching device according to the invention in a second embodiment thereof;

FIG. 8 is a cross-sectional side view of the punching device according to the invention in the second embodiment of FIG. 7.

With reference to the figures, a gas-actuated hold-down for punching devices is generally designated with the reference numeral 10.

The hold-down 10 comprises:
a tubular containment body 11,
a hold-down element 12, adapted to translate within the tubular body 11 in order to protrude from and retract into a first end 13 thereof,
a tubular punch die-covering element 14, which is coaxial to the tubular body 11, for guiding the hold-down element 12,
an annular closure body 15, designed to close the tubular containment body 11 at the opposite second end 16 thereof,
a pressure chamber 17 defined between the tubular body 11, the tubular punch die-covering element 14, the hold-down element 12 and the annular closure body 15,
a fixing flange 18, which widens radially from the tubular containment body 11 at the second end 16 thereof.

The tubular punch die-covering element 14 and the annular closure body 15 are constituted by a single piece in which the annular closure body 15 extends radially from the tubular punch die-covering element 14.

A punch die is indicated with the reference numeral 21.

The fixing flange 18 has a through charging hole 19 which extends from a surface that is exposed in the configuration for use of the hold-down 10 up to the pressure chamber 17.

The exposed surface is constituted by the lateral surface 20 of the fixing flange 18.

In particular, in the present embodiment, the through charging hole 19 extends in a radial direction with respect to the main axis of symmetry X of the hold-down 10.

The through charging hole 19 has a threaded portion 22 for the insertion of a gas charging valve 23 and of a closure plug 24.

In the present, non-limiting embodiment of the invention, the hold-down element 12 comprises two separate parts:
a first part 25, which is internal to the tubular body 11 and is contoured to slide between the tubular body 11 and the tubular punch die-covering element 14 and is provided with an annular abutment portion 26, which is adapted for abutment against an extraction-preventing shoulder 27 defined on the inner face of the tubular body 11;
and a second part 28, which rests axially on the first part 25, comprising a hold-down body 29 with a punch die passage hole 30 and an extraction-preventing shoulder 31, and designed to protrude from the first end 13 in the configuration for operation.

The second part 28 is retained within the tubular body 11 by an open elastic stop ring 32 which is inserted reversibly in a corresponding annular seat 71 in the first end 13 of the tubular body 11; such stop ring 32 is adapted to receive in abutment the extraction-preventing shoulder 31.

Such embodiment makes it possible, by removing the elastic stop ring 32, with the use of a tool that is known per se and designed to be inserted in one or more corresponding radial openings for removal 70, to extract the second part 28 of the hold-down element 12 without discharging the gas from the chamber 17, so as to be able to contour the hold-down body 29 of the second part 28, or to substitute the second part 28 of the hold-down element 12 with another of which the hold-down body 29 is contoured differently, according to the shape and profile of the sheet metal to be punched.

The first part 25 of the hold-down element 12, inside the tubular body 11, is surrounded by a rotation-preventing band for guiding and lubrication 33.

The rotation-preventing band 33 comprises an annular portion 34 of larger diameter, and a portion 35 of smaller diameter, which define a positioning abutment 36 for the location of a corresponding shoulder 37 defined inside the tubular body 11.

The rotation-preventing band 33 also has a double rotation-preventing flattened region, indicated in the figures with the reference numerals 38 for the outer flattened region and 39 for the inner flattened region.

The rotation-preventing band 33 is made of a self-lubricating material.

The rotation-preventing band 33 is made preferably by molding, but it can also be made with other processes and production methods.

The two flattened regions 38 and 39 prevent the rotation of the first part 25 of the hold-down element 12 with respect to the tubular body 11.

The rotation-preventing band 33 is locked to the tubular containment body 11 by way of one or more grub screws 40 which are screwed radially on the tubular body 11 so as to pass through, until they press against the rotation-preventing band 33; the rotation-preventing band 33 can be also lockable with other means and devices that are similar and equivalent.

The first part 25 and the second part 28 of the hold-down element 12 are also associated with each other by way of means adapted to prevent the mutual rotation.

Such means adapted to prevent the mutual rotation between the two parts 25 and 28 of the hold-down element 12 are constituted by at least one tab 41 which extends from one of the two parts toward the other one, in this case from the second part 28, adapted to be inserted in a corresponding complementarily shaped recess 42 defined on the other part, in this case the first part 25.

The first part 25 carries external holding and guiding means 44 for sliding on the inner surface of the tubular body 11, and internal holding and guiding means 45 and 46 for sliding on the tubular punch die-covering element 14.

The external holding and guiding means 44 take the form of a first annular guide band.

The internal holding and guiding means are constituted by a second annular guide band 45 and by an internal scraper ring 46.

The first part 25 of the hold-down element 12 also carries, inside the pressure chamber 17, an elastic sealing ring 47, contoured to adhere both to the tubular containment body 11 and to the tubular punch die-covering element 14.

Above the rotation-preventing band 33 an oil scraper 48 is provided for protecting the rotation-preventing band 33.

The annular closure body 15, which is part of the tubular punch die-covering element 14, is fixed to the inside of the second end 16 of the tubular containment body 11 by way of a retaining ring 73, which is partially positioned in a corresponding annular seat 74 defined on the inner surface of the second end 16, so as to protrude from the annular seat 74 toward the inside of the tubular containment body 11; the annular body 15 is perimetrically provided with an abutment shoulder 75 which is contoured to make contact with the part of the retaining ring 73 that protrudes from the annular seat 74.

The annular body 15 is perimetrically provided with a sealing ring 76, for example of the ‘dual ring’ type, which is adapted to seal closed the second end 16 of the tubular containment body 11.

The fixing flange 18 has a through fixing hole 61 which extends in a parallel direction to the main axis X of the hold-down 10.

The invention also relates to a punching device 50 with a hold-down 10 as described above.

In a first embodiment thereof, shown in FIG. 6, the punching device 50 comprises:
a punch die-supporting body 51 with means for quick and reversible coupling for a punch die 21,
means for the precision fixing of the hold-down 10 to the punch die-supporting body 51.

Such means for quick and reversible coupling for a punch die 21 comprise a ball 52 which protrudes by a portion thereof from an opening 53 which faces a hole 54 for the insertion of a shank 55 of the punch die 21.

The shank 55 has a hollow 56 for coupling to the ball portion 52.

The ball 52 is pushed so as to protrude from the opening 53 by way of an elastic pusher 57, for example a helical spring, which is arranged in a corresponding seat 58 on the punch die-supporting body 51.

Such system of rapid engagement and disengagement makes it possible to extract the punch die from the punch die-supporting body without having to remove the punch die from the side of the punch die-supporting body that is directed toward the slider, instead extracting it from the hold-down side, therefore more rapidly.

The means for the precision fixing of the hold-down 10 to the punch die-supporting body 51 are constituted by a screw 59 with a ground shank 60, which is adapted to pass through a through hole 61 on the fixing flange 18 and to be screwed to a corresponding complementarily threaded hole 62 defined in the punch die-supporting body 51.

The means of fixing of the punch die-supporting body 51 to a generic slider 64 of a press comprise, for example, a plurality of centering pins 65 and one or more threaded connecting elements 66.

In a second embodiment thereof, which is also understood to be illustrative and non-limiting of the invention, the punching device, indicated in FIGS. 7 and 8 with the reference numeral 150, comprises, similarly to what is described for the first embodiment of the punching device 50:
a hold-down 10,
a punch die-supporting body 151 with means for quick and reversible coupling for a punch die 121,
means for the precision fixing of the hold-down 10 to the punch die-supporting body 151.

The peculiarity of such second embodiment of the punching device 150 consists in that the punch die-supporting body 151 is of the type known as ‘ISO 8020’ and thus contoured to carry a punch die 121 with a widened extraction-preventing end 170 which is provided with a rotation-preventing lateral flattened region 171, clearly visible in FIG. 7.

The quick and reversible engagement means for the punch die 121 are constituted by the widened extraction-preventing end 170, which is designed to be inserted in a complementarily shaped seat 173 defined by the part of the punch die-supporting body that is adapted to face the slider.

Such embodiment ensures the stability, both axial and rotational, of the punch die with respect to the punch die-supporting body.

In order to remove the punch die it is necessary to remove the punch die-supporting body from the slider and take out the punch die from the part of the punch die-supporting body that is directed toward the slider.

In practice it has been found that the invention fully achieves the intended aim and objects.

In particular, with the invention a hold-down 10 has been provided thanks to which the operations to recharge the gas and restore the pressure are more convenient and rapid to carry out with respect to conventional hold-downs, thanks to the through charging hole 19 which is available laterally to the hold-down 10 and is accessible without the need to remove the hold-down 10 proper from the slider of the press or from a punch die-supporting body 51 and 151 on which it is fitted.

With such a hold-down 10 according to the invention it is further advantageously possible to connect a plurality of hold-downs 10 in parallel, creating a circuit, with adapted tubes, through which to control the status of the pressure of all the hold-downs simultaneously by an adapted control panel; this is particularly advantageous for reducing to the minimum the periods of shutting down the operation of the press and thus of interrupting production.

Moreover, with the invention a punching device 50 and 150 is provided thanks to which the possible positioning inaccuracies of the hold-down are limited, by way of the use of a screw 59 with a ground shank 60, which enables a precision of fixing that is much greater than the adoption of a screw of standard type.

The invention, thus conceived, is susceptible of numerous modifications and variations, all of which are within the scope of the appended claims Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. PD2015A000049 (102015902334954) from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

What is claimed is:

1. A gas-actuated hold-down for punching devices, comprising:
a tubular containment body,
a hold-down element, adapted to translate within said tubular body in order to protrude from and retract into a first end thereof,
a tubular punch die-covering element, which is coaxial to said tubular body, for guiding said hold-down element,
an annular closure body, designed to close said tubular containment body at an opposite second end thereof,
a pressure chamber defined between said tubular body, said tubular punch die-covering element, said hold-down element and said annular closure body,
a fixing flange, which widens radially from said tubular containment body at said second end thereof,
said fixing flange having a through charging hole which extends in a radial direction with respect to a main axis of the hold-down, from a surface that is exposed in a configuration for use of the hold-down up to said pressure chamber.

2. The hold-down according to claim 1, wherein said exposed surface is constituted by the lateral surface of said fixing flange.

3. The hold-down according to claim 1, wherein said through charging hole has a threaded portion for the insertion of a gas charging valve and of a closure plug.

4. The hold-down according to claim 1, wherein said hold-down element comprises two separate parts:
a first part, which is internal to the tubular body and is contoured to slide between the tubular body and the tubular punch die-covering element and is provided with an annular abutment portion, which is adapted for abutment against an extraction-preventing shoulder defined on the inner face of the tubular body,
and a second part, which rests axially on said first part, comprising a hold-down body with a punch die passage hole and an extraction-preventing shoulder, said second part being designed to protrude from the first end in the configuration for operation, said second part being retained within the tubular body by a stop ring which is inserted in said first end of the tubular body and is adapted to receive in abutment said extraction-preventing shoulder.

5. The hold-down according to claim 1, wherein said fixing flange has a through fixing hole which extends in a direction parallel to the main axis of said hold-down.

6. A punching device with gas-actuated hold-down according to claim 1, comprising:
a hold-down,
a punch die-supporting body with means for quick and reversible coupling for a punch die,
means for the precision fixing of said hold-down to said punch die-supporting body.

7. The punching device according to claim 6, wherein said means for quick and reversible coupling for a punch die comprise a ball which protrudes by a portion thereof from an opening which faces a hole for the insertion of a shank of said punch die, said shank having a hollow for coupling to said ball portion, said ball being pushed so as to protrude from said opening by way of an elastic pusher arranged in a corresponding seat on said punch die-supporting body.

8. The punching device according to claim 6, wherein said means for the precision fixing of said hold-down to said punch die-supporting body comprise a screw with a ground shank, which is adapted to pass through said through hole on said fixing flange and to be screwed to a corresponding complementarily threaded hole defined in said punch die-supporting body.

9. The punching device according to claim 6, wherein the punch die-supporting body is contoured to support a punch die with a widened extraction-preventing end which is provided with a rotation-preventing lateral flattened region.

10. The punching device according to claim 9, wherein said quick and reversible engagement means for the punch die are constituted by said widened extraction-preventing end, which is designed to be inserted in a complementarily shaped seat defined by the part of the punch die-supporting body that is adapted to face the slider.
